(19) United States
(12) Patent Application Publication
(10) Pub. No.: US 2010/0321945 A1
(43) Pub. Date: Dec. 23, 2010

(54) VEHICULAR GRAPHICS PROJECTION SYSTEM

(75) Inventors: Steven C. LANG, COLUMBUS, MI (US); David A. DINGMAN, GRAND HAVEN, MI (US); Peter A. LAWLIS, TROY, MI (US); Eric M. CLOUGH, BEVERLY HILLS, MI (US); Ryan J. SNIP, ALLENDALE, MI (US); Tyler J. HOP, HOLLAND, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/488,339

(22) Filed: Jun. 19, 2009

(51) Int. Cl. B60Q 1/26

(52) U.S. Cl. 362/501; 362/487

(57) ABSTRACT

A lighting apparatus for an automobile generally includes a projection device coupled to the automobile (e.g., an external component, such as a door handle assembly) wherein the projection device is configured to project an image onto a display surface that is external to the automobile (e.g., the ground adjacent to a door of the automobile or a region near the door handle itself). The lighting apparatus is configured to activate in response to one or more events, such as proximity of a key fob, the unlocking of one or doors, or the like.

### TECHNICAL FIELD

The present invention generally relates to the automotive lighting, and more particularly relates to methods and systems for methods and apparatus for displaying symbols and other graphics external to an automobile.

### BACKGROUND

Lighting systems play a number of roles in modern automobiles—e.g., providing needed illumination and convenience lighting at various points both external and external to the vehicle. For example, external lighting may be used to light the region of the ground adjacent to the doors to assist ingress and egress, or to light the external door handle pocket itself.

At the same time, it is generally advantageous to build brand consciousness in consumers in the form of badges, logos, graphics, and other indicia relating to an automotive brand or model.

Accordingly, it is desirable to provide improved external lighting systems that can be used with associated branding for automobiles and other vehicles. Additional desirable features and characteristics of the present invention will become apparent from the subsequent detailed description and the appended claims, taken in conjunction with the accompanying drawings and the foregoing technical field and background.

### BRIEF SUMMARY

A lighting apparatus for an automobile generally includes a projection device coupled to the automobile (e.g., an external component, such as a door handle assembly) wherein the projection device is configured to project an image onto a display surface that is external to the automobile (e.g., the ground adjacent to a door of the automobile or a region near the door handle itself). The lighting apparatus is configured to activate in response to one or more events, such as proximity of a key fob, the unlocking of one or doors, or the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a general overview of an automobile exterior illustrating one embodiment of the present invention;

FIG. 2 is a cut-way view of an illumination device in accordance with one embodiment;

FIG. 3 is an assembled view of the illumination device shown in FIG. 2.;

FIG. 4 is an exemplary door handle including the illumination device shown in FIG. 3;

FIG. 5 is an exemplary image projection; and

FIGS. 6 and 7 depict illumination devices in accordance with alternate embodiments.

### DETAILED DESCRIPTION

The following discussion generally relates to an external graphical display system for an automobile. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to lighting systems, light-emitting diodes, automotive exteriors and the like need not be described in detail herein.

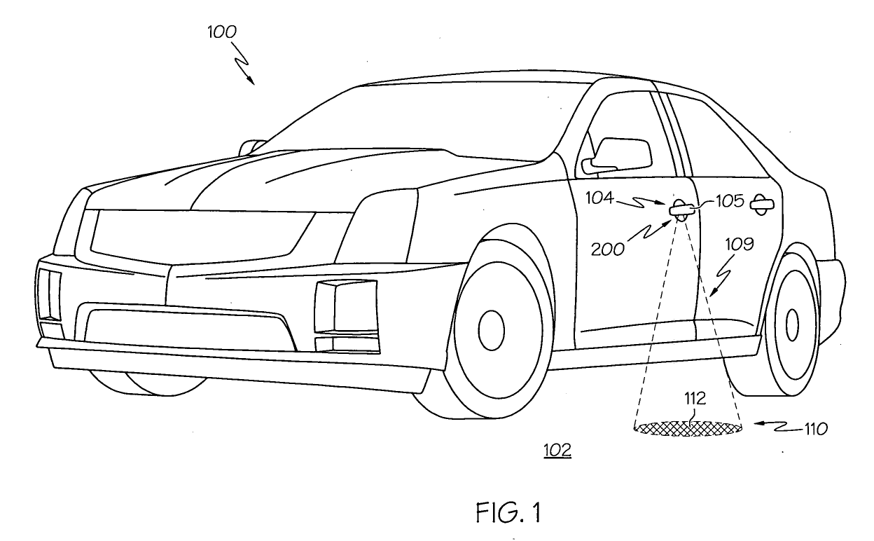

Referring to the exemplary automobile 100 illustrated in FIG. 1, a vehicular lighting apparatus in accordance one embodiment generally includes a projection device 200 coupled to automobile 100 (for example, a external door handle 104) and configured to project an image 112 onto a display surface (e.g., surface 110) that is external to automobile 100.

The display surface may be any external surface. In one embodiment, the display surface is a region on the body of the automobile itself, e.g., a generally concave surface adjacent an outside handle assembly 104. In another embodiment, the display surface is a region on the ground 102 adjacent the automobile, for example, adjacent to a side door of the automobile, thereby functioning as a “puddle light.”

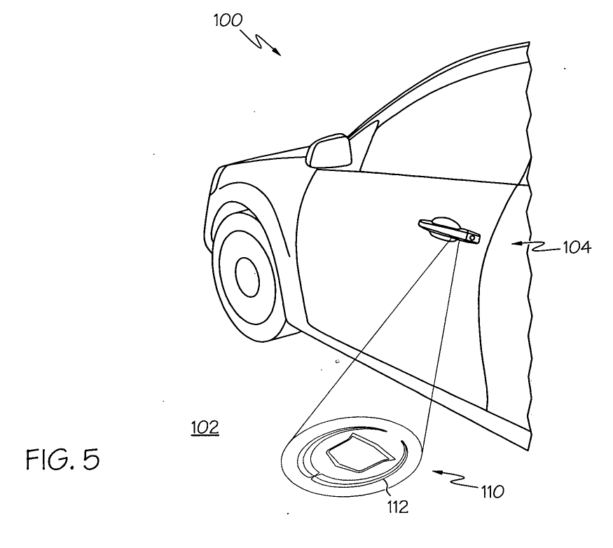

Image 112 may include any combination of graphics, alphanumeric test, etc. In various embodiments, for example, image 112 consists of automotive brand indicia (e.g., “Cadillac”), model indicia (e.g., “STS”), and/or any desired branding or badging indicia. FIG. 5, for example, shows just such an example of a projected badge.

Referring again to FIG. 1, as shown in the illustrated embodiment, projection device 200 is integrated into an outside handle assembly 104 of automobile 100. In a particular embodiment, the projection device is incorporated into the door handle lever 105 and is configured to project the image generally downward with respect to automobile 100.

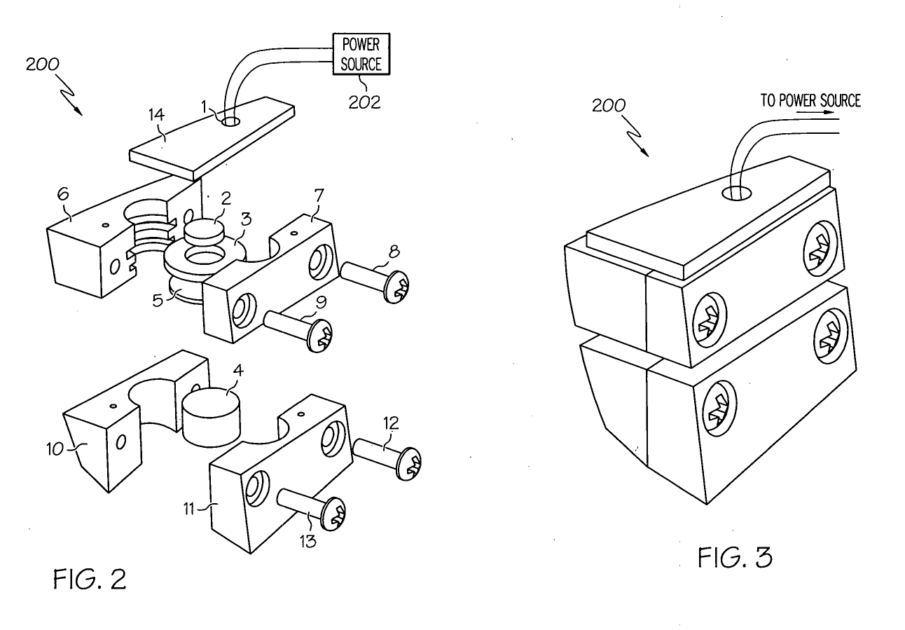

Referring to FIG. 2, an exemplary projection device 200 generally includes one or more LEDs 1, a condenser lens 2 mounted within a condenser lens housing 3, and a focusing lens 4. An optical component 5 (e.g., an emblem, badge, or any other component that bears a graphical design corresponding to the desired image) is configured such that light generated by LED can project therethrough. Optical component 5 may be monochrome or color, and may contain opaque, transparent, and/or translucent feature regions. In one embodiment, optical component comprises a laser-etched lens as is known in the art.

Light emitting diode 2, which may be any suitable LED type or color (RGB, etc.) is configured to emit light toward the display surface along an optical path. Optical component 5 is placed between the light emitting diode and the display surface.

The various components 1, 2, 3, and 4 are aligned axially within a clamshell housing structure, which may monolithic or assembled from multiple subcomponents. As illustrated in FIG. 2, a “clamshell” configuration may be used. That is, two housing pieces 6 and 7 each contain two slots and a set of screw holes, which together are used to hold condenser lens 2 and optical component 5. Once the lens and component are properly positioned, the two pieces 6 and 7 are secured, e.g., via screws 8 and 9.

Housing pieces 10 and 11 are used to hold focusing lens 4, which is located in one half of the housing, and are attached using for example two screws 12 and 13. LED 1 may be mounted to a heat sink (e.g., an aluminum heat sink), a PCB 14, or any other substrate. ). In one embodiment, the spacing between the axially-aligned components are adjustable to accommodate the geometry of the automobile and display focal distance.

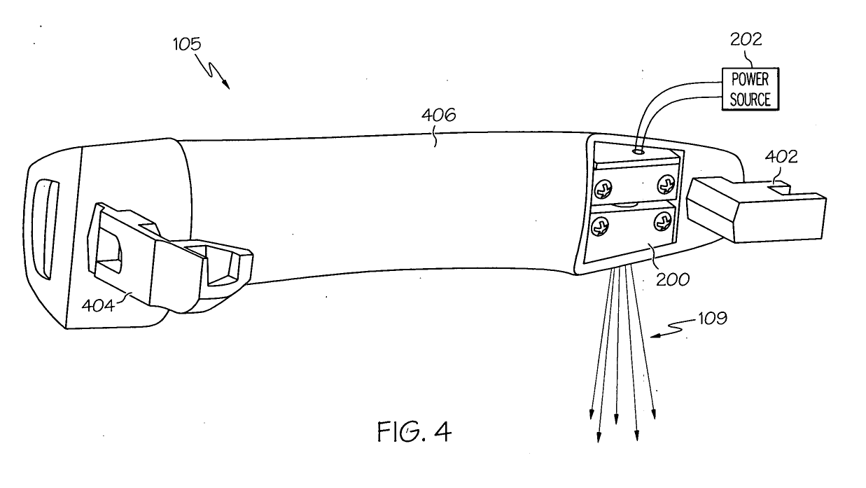

The resulting component 200 is shown in FIG. 3. As illustrated in FIG. 4, the assembly of FIG. 3 is compact and may be inserted within a door handle 105, which will typically include a hinge 402 and latch 404, as is known in the art. The present invention is not so limited, however, and may be embedded within any type of door latch assembly or indeed any external feature of the automobile.

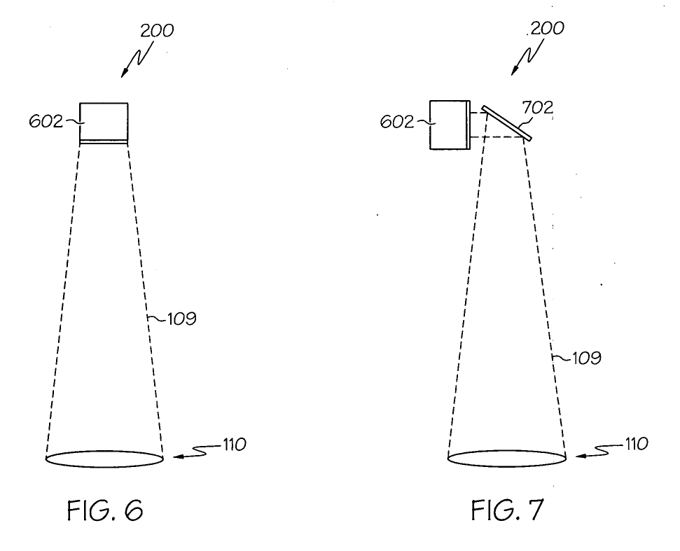

While the illustrated embodiment depicts an LED device, the present invention is not so limited. Any type of projection device now known or later developed may be used. FIGS. 6 and 7, for example, show additional embodiments incorporating one or more a display field components comprising individually-actuatable color or monochrome pixels capable of projecting an arbitrary image, which may be static or dynamic. That is, in FIG. 6, an LCD projection device 602 is configured to project a light image downward, and may accompanied by any number of additional lenses or other optical components (not shown). Similarly, as shown in FIG. 7, a mirror 702 may work in conjunction with LCD projection device 602 to project the image to the desired surface.

A selectively actuated power source 202 is suitably coupled to led 1 (e.g., via wires, metal traces, or the like) to activate projection device 200. Power source 202 may be any suitable DC power source, e.g., a battery or the like, and might be accompanied by a variety of additional passive and active components. Power source 202 preferably communicates with logic within one or more GPUs and/or relays located within the automobile, and is able to vary the intensity of light generated by LED 1 (e.g., to provide a smooth on/off behavior).

In accordance with one aspect, power source 202 is configured to activate projection device 200 when a particular event occurs. For example, the projection may be activated when one or more doors of the automobile are unlocked, when an RFID tag or other proximity device is located within a predetermined distance from the automobile, or when activated manually by a human being.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. For example, while a standard automobile is illustrated, the present invention may be used in connection with trucks, motorcycles, RVs, or any other vehicle. The foregoing detailed description provides those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A lighting apparatus for an automobile, comprising:
a projection device coupled to the automobile;
wherein the projection device is configured to project an image onto a display surface that is external to the automobile.

2. The apparatus of claim 1, wherein the display surface is an external surface of the body of the automobile.

3. The apparatus of claim 2, wherein the external surface is a generally concave surface adjacent an outside handle assembly of the automobile.

4. The apparatus of claim 1, wherein the display surface is a region on the ground adjacent the automobile.

5. The apparatus of claim 4, wherein the display surface is adjacent a side door of the automobile.

6. The apparatus of claim 1, wherein the projection device is integrated into an outside handle assembly of the automobile.

7. The apparatus of claim 6, wherein the outside handle assembly includes a door handle lever, and wherein the projection device is integrated into the door handle lever and is configured to project the image generally downward with respect to the automobile.

8. The apparatus of claim 7, wherein the projection device includes a light emitting diode configured to emit light toward the display surface along an optical path.

9. The apparatus of claim 8, wherein the projection device includes an optical component between the light emitting diode and the display surface, and wherein the optical component bears a graphical design corresponding to the image.

10. The apparatus of claim 9, wherein the optical component is a laser-etched lens.

11. The apparatus of claim 9, further including a condenser lens between the light emitting diode and the optical component.

12. The apparatus of claim 11, further including a focusing lens between the optical component and the display surface.

13. The apparatus of claim 12, wherein the condenser lens, light emitting diode, optical component, and focusing lens are aligned axially within a clamshell housing structure.

14. The apparatus of claim 1, wherein the image includes indicia selected from the group consisting of automotive brand indicia and automotive type indicia.

15. The apparatus of claim 1, further including a controllable power source coupled to and configured to activate the projection device.

16. The apparatus of claim 1, wherein the power source is configured to activate the projection device when one or more doors of the automobile are unlocked.

17. An outside handle assembly for an automobile comprising:
a lighting apparatus including a projection device configured to project an image onto a display surface external to the automobile, wherein the projection device includes a light emitting diode configured to emit light toward the display surface along an optical path, and an emblem component positioned between the light emitting diode and the display surface such that projected image corresponds to the emblem component; and
a power source coupled to the lighting apparatus and configured to selectively activate the lighting apparatus in response to one or more user-generated event.

18. The assembly of claim 17, wherein the external surface is a region on the ground adjacent the automobile, and wherein the user-generated event includes unlocking the outside handle assembly.

19. A method for providing external lighting for an automobile, the method comprising:
receiving a user-generated event associated with the automobile; and
projecting an image on a display surface external to the automobile in response to the user-generated event.

20. The method of claim 19, wherein:
the user-generated event includes unlocking a door of the automobile;
the display surface includes a ground surface adjacent to the door of the automobile; and
the image includes indicia associated with a brand or a type of the automobile.
